(19) United States
(12) Patent Application Publication
(10) Pub. No.: US 2019/0263052 A1
(43) Pub. Date: Aug. 29, 2019

(54) THERMOPLASTIC POLYESTER FOR PRODUCING 3D-PRINTED OBJECTS

(71) Applicant: ROQUETTE FRERES, Lestrem (FR)

(72) Inventors: Hélène AMEDRO, BETHUNE (FR); René SAINT-LOUP, LOMME (FR)

(21) Appl. No.: 16/319,898

(22) PCT Filed: Jul. 28, 2017
(86) PCT No.: PCT/FR2017/052143

§ 371 Date: Jan. 23, 2019

(30) Foreign Application Priority Data
Jul. 29, 2016 (FR) 16 57429

(51) Int. Cl. B29C 64/118; B29C 64/153; C08G 63/672

(52) U.S. Cl. CPC B29C 64/118; B33Y 10/00; C08G 63/672; B29C 64/153

(57) ABSTRACT

Use of a thermoplastic polyester for producing 3D-printed objects, said polyester having at least one 1,4:3,6-dianhydrohexitol unit (A), at least one alicyclic diol unit (B) other than the 1,4:3,6-dianhydrohexitol units (A), at least one terephthalic acid unit (C), wherein the ratio (A)/[(A)+(B)] is at least 0.05 and at most 0.75, said polyester being free of non-cyclic aliphatic diol units or comprising a molar amount of non-cyclic aliphatic diol units, relative to the totality of monomeric units in the polyester, of less than 5%, and with a reduced viscosity in solution (25° C.; phenol (50 wt. %): ortho-dichlorobenzene (50 wt. %); 5 g/L of polyester) greater than 50 mL/g.

### FIELD OF THE INVENTION

The present invention relates to the field of 3D-printing and relates in particular to the use of a thermoplastic polyester for producing 3D-printed objects, said thermoplastic polyester having properties that are particularly advantageous for this application.

### TECHNICAL BACKGROUND OF THE INVENTION

The 3D-printing field has experienced a boom over the past few decades. At the current time, it is possible to produce 3D-printed objects in a multitude of materials, for instance plastic, wax, metal, plaster of Paris or else ceramics.

Despite this variety of materials that can be used, the choice of compounds that are available within each material is sometimes limited.

With regard to 3D-printed objects made of plastics, few polymers can be used, in particular for the filament spools used in some 3D-printing techniques.

At the current time, polymers such as ABS (acrylonitrile-butadiene-styrene) and PLA (polylactic acid) are the main participants, with in addition polyamides and photoresins or photopolymers.

ABS is an amorphous polymer, the Tg of which changes from 100 to 115° C. depending on its composition, and has several limitations in its processing. Specifically, its use requires relatively high process temperatures of 220 to 240° C., but especially a bed temperature of 80° C. to 110° C., which requires particularly suitable instrumentation. Furthermore, for obtaining bulk objects, the use of ABS in all cases results in runs and apparent cracks on the final object because of a very marked shrinkage.

PLA, to which polyhydroxy alkanoate is generally added, is less demanding in terms of the required temperatures, and one of its main characteristics lies in its low shrinkage on 3D-printing, which is why the use of a hotplate is not necessary when 3D-printing using the FDM (Fused Deposition Modeling) technique. However, its main limitation lies in a low glass transition temperature of the blend, which is about 60° C.

Thus, there is at the current time still a need for alternative plastic starting materials, and in particular thermoplastic polymers, for use in 3D-printing.

Certain thermoplastic aromatic polyesters have thermal properties which allow them to be used directly for the production of materials. They comprise aliphatic diol and aromatic diacid units. Among these aromatic polyesters, mention may be made of polyethylene terephthalate (PET), which is a polyester comprising ethylene glycol and terephthalic acid units.

However, for certain applications or under certain usage conditions, it is necessary to improve certain properties, especially impact strength or else heat resistance. This is why glycol-modified PETs (PETgs) have been developed. They are generally polyesters comprising, in addition to the ethylene glycol and terephthalic acid units, cyclohexanedimethanol (CHDM) units. The introduction of this diol into the PET enables it to adapt the properties to the intended application, for example to improve its impact strength or its optical properties, especially when the PETg is amorphous.

Other modified PETs have also been developed by introducing, into the polyester, 1,4:3,6-dianhydrohexitol units, especially isosorbide (PEIT). These modified polyesters have higher glass transition temperatures than the unmodified PETs or PETgs comprising CHDM. In addition, 1,4:3,6-dianhydrohexitols have the advantage of being able to be obtained from renewable resources such as starch.

One drawback with these PEITs is that they may have insufficient impact strength properties. In addition, the glass transition temperature may be insufficient for the production of certain plastic objects.

In order to improve the impact strength properties of the polyesters, it is known from the prior art to use polyesters in which the crystallinity has been reduced. As regards isosorbide-based polyesters, mention may be made of application US2012/0177854, which describes polyesters comprising terephthalic acid units and diol units comprising from 1 to 60 mol % of isosorbide and from 5 to 99% of 1,4-cyclohexanedimethanol which have improved impact strength properties.

As indicated in the introductory section of this application, the aim is to obtain polymers in which the crystallinity is eliminated by the addition of comonomers, and hence in this case by the addition of 1,4-cyclohexanedimethanol. In the examples section, the production of various poly(ethylene-co-1,4-cyclohexanedimethylene-co-isosorbide)terephthalates (PECITs), and also an example of poly(1,4-cyclohexanedimethylene-co-isosorbide)terephthalate (PCIT), are described.

It may also be noted that while polymers of PECIT type have been the subject of commercial developments, this is not the case for PCITs. Indeed, their production was hitherto considered to be complex, since isosorbide has low reactivity as a secondary diol. Yoon et al. (Synthesis and Characteristics of a Biobased High-Tg Terpolyester of Isosorbide, Ethylene Glycol, and 1,4-Cyclohexane Dimethanok Effect of Ethylene Glycol as a Chain Linker on Polymerization, Macromolecules, 2013, 46, 7219-7231) thus showed that the synthesis of PCIT is much more difficult to achieve than that of PECIT. This paper describes the study of the influence of the ethylene glycol content on the PECIT production kinetics.

In Yoon et al., an amorphous PCIT (which comprises approximately 29% isosorbide and 71% CHDM, relative to the sum of the diols) is produced to compare its synthesis and its properties with those of PECIT-type polymers. The use of high temperatures during the synthesis induces thermal degradation of the polymer formed if reference is made to the first paragraph of the Synthesis section on page 7222, this degradation especially being linked to the presence of aliphatic cyclic diols such as isosorbide. Therefore, Yoon et al. used a process in which the polycondensation temperature is limited to 270° C. Yoon et al. observed that, even increasing the polymerization time, the process also does not make it possible to obtain a polyester having a sufficient viscosity. Thus, without addition of ethylene glycol, the viscosity of the polyester remains limited, despite the use of prolonged synthesis times.

It is thus to the applicant's credit to have found that this need for alternative plastic starting materials for use in 3D-printing can be achieved, against all expectations, with a thermoplastic polyester based on isosorbide and not having ethylene glycol, while it was hitherto known that the latter was essential for the incorporation of said isosorbide.

### SUMMARY OF THE INVENTION

Thus, a subject of the invention is the use of a thermoplastic polyester for producing 3D-printed objects, said polyester comprising:
at least one 1,4:3,6-dianhydrohexitol unit (A);
at least one alicyclic diol unit (B) other than the 1,4:3,6-dianhydrohexitol units (A);
at least one terephthalic acid unit (C);
wherein the (A)/[(A)+(B)] ratio is at least 0.05 and at most 0.75;
   said polyester not containing any aliphatic non-cyclic diol units or comprising a molar amount of aliphatic non-cyclic diol units, relative to all the monomer units of the polyester, of less than 5%, and the reduced solution viscosity (25° C.; phenol (50% m): ortho-dichlorobenzene (50% m); 5 g/l of polyester) of said polyester being greater than 50 ml/g.

A second subject of the invention relates to a process for producing a 3D-printed object from the thermoplastic polyester described above.

Finally, a third subject relates to a 3D-printed object comprising the thermoplastic polyester previously described.

The thermoplastic polyesters used according to the present invention offer excellent properties and make it possible to produce 3D-printed objects.

The polymer composition according to the invention is particularly advantageous and has improved properties. Indeed, the presence of the thermoplastic polyester in the composition makes it possible to introduce additional properties and to broaden the fields of applications of other polymers.

The thermoplastic polyester according to the invention thus has very good properties, in particular mechanical properties, and is particularly suitable for use in the production of 3D-printed objects.

### DETAILED DESCRIPTION OF THE INVENTION

A first subject of the invention relates to the use of a thermoplastic polyester for producing 3D-printed objects, said polyester comprising:
at least one 1,4:3,6-dianhydrohexitol unit (A);
at least one alicyclic diol unit (B) other than the 1,4:3,6-dianhydrohexitol units (A);
at least one terephthalic acid unit (C);
   wherein the (A)/[(A)+(B)] molar ratio is at least 0.05 and at most 0.75 and the reduced solution viscosity is greater than 50 ml/g.

“(A)/[(A)+(B)] molar ratio” is intended to mean the molar ratio of 1,4:3,6-dianhydrohexitol units (A)/sum of 1,4:3,6-dianhydrohexitol units (A) and alicyclic diol units (B) other than the 1,4:3,6-dianhydrohexitol units (A).

The thermoplastic polyester does not contain any aliphatic non-cyclic diol units, or comprises a small amount thereof.

“Small molar amount of aliphatic non-cyclic diol units” is intended to mean, especially, a molar amount of aliphatic non-cyclic diol units of less than 5%. According to the invention, this molar amount represents the ratio of the sum of the aliphatic non-cyclic diol units, these units possibly being identical or different, relative to all the monomer units of the polyester.

An aliphatic non-cyclic diol may be a linear or branched aliphatic non-cyclic diol. It may also be a saturated or unsaturated aliphatic non-cyclic diol. Aside from ethylene glycol, the saturated linear aliphatic non-cyclic diol may for example be 1,3-propanediol, 1,4-butanediol, 1,5-pentanediol, 1,6-hexanediol, 1,8-octanediol and/or 1,10-decanediol. As examples of saturated branched aliphatic non-cyclic diol, mention may be made of 2-methyl-1,3-propanediol, 2,2,4-trimethyl-1,3-pentanediol, 2-ethyl-2-butyl-1,3-propanediol, propylene glycol and/or neopentyl glycol. As an example of an unsaturated aliphatic diol, mention may be made, for example, of cis-2-butene-1,4-diol.

This molar amount of aliphatic non-cyclic diol unit is advantageously less than 1%. Preferably, the polyester does not contain any aliphatic non-cyclic diol units and more preferentially it does not contain any ethylene glycol.

Despite the low amount of aliphatic non-cyclic diol, and hence of ethylene glycol, used for the synthesis, a thermoplastic polyester is surprisingly obtained which has a high reduced solution viscosity and in which the isosorbide is particularly well incorporated. Without being bound by any one theory, this would be explained by the fact that the reaction kinetics of ethylene glycol are much faster than those of 1,4:3,6-dianhydrohexitol, which greatly limits the integration of the latter into the polyester. The polyesters resulting therefrom thus have a low degree of integration of 1,4:3,6-dianhydrohexitol and consequently a relatively low glass transition temperature.

The monomer (A) is a 1,4:3,6-dianhydrohexitol and may be isosorbide, isomannide, isoidide, or a mixture thereof. Preferably, the 1,4:3,6-dianhydrohexitol (A) is isosorbide. Isosorbide, isomannide and isoidide may be obtained, respectively, by dehydration of sorbitol, of mannitol and of iditol. As regards isosorbide, it is sold by the applicant under the brand name Polysorb® P.

The alicyclic diol (B) is also referred to as aliphatic and cyclic diol. It is a diol which may especially be chosen from 1,4-cyclohexanedimethanol, 1,2-cyclohexanedimethanol, 1,3-cyclohexanedimethanol or a mixture of these diols. The alicyclic diol (B) is very preferentially 1,4-cyclohexanedimethanol. The alicyclic diol (B) may be in the cis configuration, in the trans configuration, or may be a mixture of diols in the cis and trans configurations.

The molar ratio of 1,4:3,6-dianhydrohexitol units (A)/sum of 1,4:3,6-dianhydrohexitol units (A) and alicyclic diol units (B) other than the 1,4:3,6-dianhydrohexitol units (A), i.e. (A)/[(A)+(B)], is at least 0.05 and at most 0.75. When the (A)/[(A)+(B)] molar ratio is less than 0.30, the thermoplastic polyester is semicrystalline and is characterized by the presence of a crystalline phase which results in the presence of X-ray diffraction lines and the presence of an endothermic melting peak in differential scanning calorimetry (DSC) analysis.

On the other hand, when the (A)/[(A)+(B)] molar ratio is greater than 0.30, the thermoplastic polyester is amorphous and is characterized by an absence of X-ray diffraction lines and by an absence of an endothermic melting peak in differential scanning calorimetry (DSC) analysis.

A thermoplastic polyester that is particularly suitable for producing 3D-printed objects comprises:
a molar amount of 1,4:3,6-dianhydrohexitol units (A) ranging from 2.5 to 54 mol %;
a molar amount of alicyclic diol units (B) other than the 1,4:3,6-dianhydrohexitol units (A) ranging from 5 to 42.5 mol %;
a molar amount of terephthalic acid units (C) ranging from 45 to 55 mol %.

Depending on the applications and on the desired properties regarding the 3D-printed object, the thermoplastic polyester may be a semicrystalline thermoplastic polyester or an amorphous thermoplastic polyester.

For example, if, for some applications, it is sought to obtain an object that can be opaque and that has improved mechanical properties, the thermoplastic polyester may be semicrystalline and thus comprises:
a molar amount of 1,4:3,6-dianhydrohexitol units (A) ranging from 2.5 to 14 mol %;
a molar amount of alicyclic diol units (B) other than the 1,4:3,6-dianhydrohexitol units (A) ranging from 31 to 42.5 mol %;
a molar amount of terephthalic acid units (C) ranging from 45 to 55 mol %.

Advantageously, when the thermoplastic polyester is semicrystalline, it has an (A)/[(A)+(B)] molar ratio of 0.10 to 0.25.

Conversely, when it is desired for the object to be transparent, the thermoplastic polyester may be amorphous and thus comprises:
a molar amount of 1,4:3,6-dianhydrohexitol units (A) ranging from 16 to 54 mol %;
a molar amount of alicyclic diol units (B) other than the 1,4:3,6-dianhydrohexitol units (A) ranging from 5 to 30 mol %;
a molar amount of terephthalic acid units (C) ranging from 45 to 55 mol %.

Advantageously, when the thermoplastic polyester is amorphous, it has an (A)/[(A)+(B)] molar ratio of 0.35 to 0.65.

Those skilled in the art can readily find the analysis conditions for determining the amounts of each of the units of the thermoplastic polyester. For example, from an NMR spectrum of a poly(l,4-cyclohexanedimethylene-co-isosorbide terephthalate), the chemical shifts relating to the 1,4-cyclohexanedimethanol are between 0.9 and 2.4 ppm and 4.0 and 4.5 ppm, the chemical shifts relating to the terephthalate ring are between 7.8 and 8.4 ppm and the chemical shifts relating to the isosorbide are between 4.1 and 5.8 ppm. The integration of each signal makes it possible to determine the amount of each unit of the polyester.

The thermoplastic polyesters have a glass transition temperature ranging from 85 to 200° C., for example from 90 to 115° C. if they are semicrystalline, and for example from 116° C. to 200° C. if they are amorphous.

The glass transition temperatures and melting points are measured by conventional methods, especially using differential scanning calorimetry (DSC) using a heating rate of 10° C./min. The experimental protocol is described in detail in the examples section below.

The thermoplastic polyesters used according to the invention, when they are semicrystalline, have a melting point ranging from 210 to 295° C., for example from 240 to 285° C.

Advantageously, when the thermoplastic polyester is semicrystalline, it has a heat of fusion of greater than 10 J/g, preferably greater than 20 J/g, the measurement of this heat of fusion consisting in subjecting a sample of this polyester to a heat treatment at 170° C. for 16 hours, then in evaluating the heat of fusion by DSC by heating the sample at 10° C./min.

The thermoplastic polyester of the polymer composition according to the invention has in particular a lightness L* greater than 40. Advantageously, the lightness L* is greater than 55, preferably greater than 60, most preferentially greater than 65, for example greater than 70. The parameter L* may be determined using a spectrophotometer, via the CIE Lab model.

Finally, the reduced solution viscosity of said thermoplastic polyester used according to the invention is greater than 50 ml/g and preferably less than 150 ml/g, this viscosity being able to be measured using an Ubbelohde capillary viscometer at 25° C. in an equi-mass mixture of phenol and ortho-dichlorobenzene after dissolving the polymer at 130° C. with stirring, the concentration of polymer introduced being 5 g/l.

This test for measuring reduced solution viscosity is, due to the choice of solvents and the concentration of the polymers used, perfectly suited to determining the viscosity of the viscous polymer prepared according to the process described below.

Advantageously, when the thermoplastic polyester is semicrystalline, it has a reduced solution viscosity of greater than 70 ml/g and less than 150 ml/g and when the thermoplastic polyester is amorphous, it has a reduced solution viscosity of from 55 to 90 ml/g.

The semicrystalline or amorphous nature of the thermoplastic polyesters used according to the present invention is characterized, after a heat treatment of 16 h at 170° C., by the presence or absence of X-ray diffraction lines or of an endothermic melting peak in differential scanning calorimetry (DSC) analysis. Thus, when X-ray diffraction lines are present and an endothermic melting peak is present in differential scanning calorimetry (DSC) analysis, the thermoplastic polyester is semicrystalline, and if they are absent, it is amorphous.

According to one particular embodiment, one or more additional polymers may be used as a blend with the thermoplastic polyester for producing 3D-printed objects.

When an additional polymer is used, the latter may for example be added at the time of the forming of the thermoplastic polyester for the 3D-printing or at the time of the preparation of the thermoplastic polyester.

The additional polymer may be chosen from polyamides, photoresins, photopolymers, polyesters other than the polyester according to the invention, polystyrene, styrene copolymers, styrene-acrylonitrile copolymers, styrene-acrylonitrile-butadiene copolymers, poly(methyl methacrylate)s, acrylic copolymers, poly(ether-imide)s, poly(phenylene oxide)s such as poly(2,6-dimethylphenylene oxide), poly(phenylene sulfate)s, poly(ester-carbonate)s, polycarbonates, polysulfones, polysulfone ethers, polyether ketones, and blends of these polymers.

The additional polymer may also be a polymer which makes it possible to improve the impact properties of the polyester, especially functional polyolefins such as functionalized ethylene or propylene polymers and copolymers, core-shell copolymers or block copolymers.

One or more additives may also be added to the thermoplastic polyester during the production of 3D-printed objects in order to confer thereon particular properties.

Thus, by way of examples of additives, mention may be made of nanometric or non-nanometric, functionalized or non-functionalized fillers or fibers of organic or mineral nature. They may be silicas, zeolites, glass fibers or beads, clays, mica, titanates, silicates, graphite, calcium carbonate, carbon nanotubes, wood fibers, carbon fibers, polymer fibers, proteins, cellulose-based fibers, lignocellulosic fibers and non-destructured granular starch. These fillers or fibers can make it possible to improve the hardness, the rigidity or the surface appearance of the parts printed.

The additive may also be chosen from opacifiers, dyes and pigments. They may be chosen from cobalt acetate and the following compounds: HS-325 Sandoplast® Red BB (which is a compound bearing an azo function, also known under the name Solvent Red 195), HS-510 Sandoplast® Blue 2B which is an anthraquinone, Polysynthren® Blue R, and Clariant® RSB Violet.

The additive may also be a UV-resistance agent such as, for example, molecules of benzophenone or benzotriazole type, such as the Tinuvin™ range from BASF: tinuvin 326, tinuvin P or tinuvin 234, for example, or hindered amines such as the Chimassorb™ range from BASF: Chimassorb 2020, Chimasorb 81 or Chimassorb 944, for example.

The additive may also be a fire-proofing agent or flame retardant, such as, for example, halogenated derivatives or non-halogenated flame retardants (for example phosphorus-based derivatives such as Exolit® OP) or such as the range of melamine cyanurates (for example melapur™: melapur 200), or else aluminum or magnesium hydroxides.

Finally, the additive may also be an antistatic agent or else an anti-block agent, such as derivatives of hydrophobic molecules, for example Incroslip™ or Incromol™ from Croda.

The thermoplastic polyester according to the invention is thus used for producing 3D-printed objects.

The 3D-printed object can be produced according to the 3D-printing techniques known to those skilled in the art.

For example, the 3D-printing can be carried out by fused deposition modeling (FDM) or by selective laser sintering. Preferentially, the 3D-printing is carried out by fused deposition modeling.

3D-printing by fused deposition modeling consists in particular in extruding a thread of material made of thermoplastic polymer on a platform through a nozzle which moves along the 3 axes x, y and z. The platform descends by one level at each new layer applied, until the printing of the object is finished.

Those skilled in the art will thus be able to easily adjust the forming of the thermoplastic polyester according to the invention so that the latter can be used according to any one of the 3D-printing methods.

The thermoplastic polyester can be in the form of a thread, a filament, a rod, granules, pellets or else a powder. For example, for 3D-printing by fused deposition modeling, the thermoplastic polyester may be in the form of a rod or a thread, preferentially in the form of a thread, before being cooled and then wound. The thread spool thus obtained can thus be used in a 3D-printing machine for the production of objects. In another example, for 3D-printing by selective laser sintering, the thermoplastic polyester may be in the form of a powder.

Preferentially, when the production of the object according to the invention is carried out by 3D-printing by fused deposition modeling, the characteristics used for the 3D-printing can be optimized as a function of the semicrystalline or amorphous nature of the thermoplastic polyester.

Thus, during 3D-printing by fused deposition modeling, when the thermoplastic polyester is semicrystalline, the temperature of the printing nozzle is preferentially from 250° C. to 270° C. and the bed has a temperature of from 40° C. to 60° C. When the thermoplastic polyester is amorphous, the temperature of the printing nozzle is preferentially from 170° C. to 230° C. and the bed may or may not be heated with a temperature up to a maximum of 50° C.

According to one particular embodiment, when the production of the object is carried out by 3D-printing by fused deposition modeling starting from a semicrystalline thermoplastic polyester, said object can be recrystallized in order to make it opaque and to improve the mechanical properties, in particular the impact strength.

The recrystallization can be carried out at a temperature of from 130° C. to 150° C., preferentially from 135° C. to 145° C., for instance 140° C., for a period of from 3 h to 5 h, preferentially from 3 h 30 to 4 h 30, for instance 4 h.

The thermoplastic polyester as previously defined has many advantages for the production of 3D-printed objects.

Indeed, by virtue in particular of the molar ratio of 1,4:3,6-dianhydrohexitol units (A)/sum of 1,4:3,6-dianhydrohexitol units (A) and alicyclic diol units (B) other than the 1,4:3,6-dianhydrohexitol units (A) of at least 0.05 and of a reduced solution viscosity of greater than 50 ml/g and preferably less than 150 ml/g, the thermoplastic polyesters make it possible to obtain 3D-printed objects which do not creep, which do not crack and which have good mechanical properties, in particular in terms of impact strength.

More particularly, when the thermoplastic polyester is an amorphous thermoplastic polyester, it has a glass transition temperature that is higher than the polymers conventionally used for the production of 3D-printed objects, which makes it possible to improve the heat resistance of the objects obtained.

Next, when the thermoplastic polyester used for the production of 3D-printed objects is a semicrystalline thermoplastic polyester, the 3D-printed object has enough crystals to be physically solid and stable. The semicrystalline thermoplastic polyester then advantageously has, via a recrystallization by subsequent heating, the possibility of increasing its degree of crystallinity, which makes it possible to improve its mechanical properties, including the impact strength.

Finally, the thermoplastic polyesters according to the invention are advantageous since they make it possible, when they are blended with the usual polymers used for the production of 3D-printed objects, such as a polyamide, a photoresin or a photopolymer, to broaden the range of properties accessible to the 3D-printed objects.
A second subject of the invention relates to a process for producing 3D-printed objects, said process comprising the following steps of:

a) provision of a thermoplastic polyester as defined above,

b) forming of the thermoplastic polyester obtained in the preceding step,

c) 3D-printing of an object starting from the thermoplastic polyester formed,

d) recovery of the 3D-printed object.

The forming of step b) is adjusted by those skilled in the art as a function of the 3D-printing method used in step c).

The thermoplastic polyester can thus be formed into a thread, a filament, a rod, granules, pellets or else a powder. For example, if the 3D-printing is carried out by fused deposition modeling, the forming is advantageously a thread and in particular a wound thread. The thread spool can be obtained from an extrusion of the thermoplastic polyester in thread form, said thread subsequently being cooled and wound.

The 3D-printing can be carried out according to techniques known to those skilled in the art. For example, the 3D-printing step can be carried out by fused deposition modeling.

According to one alternative, when the polyester provided is a semicrystalline thermoplastic polyester, the process according to the invention can also comprise an additional step e) of recrystallization. This recrystallization step makes it possible in particular to render the 3D-printed object opaque and to improve its mechanical properties, such as the impact strength.

The recrystallization step can be carried out at a temperature of from 130° C. to 150° C., preferentially from 135° C. to 145° C., for instance 140° C., fora period of from 3 h to 5 h, preferentially from 3 h 30 to 4 h 30, for instance 4 h.
A third subject of the invention relates to a 3D-printed object produced from the thermoplastic polyester described previously. The 3D-printed object may also comprise one or more additional polymers and also one or more additives.

The thermoplastic polyester that is particularly suitable for the obtaining of the polymer composition can be prepared by means of a synthesis process comprising:
a step of introducing, into a reactor, monomers comprising at least one 1,4:3,6-dianhydrohexitol (A), at least one alicyclic diol (B) other than the 1,4:3,6-dianhydrohexitols (A) and at least one terephthalic acid (C), the molar ratio ((A)+(B))/(C) ranging from 1.05 to 1.5, said monomers not containing any aliphatic non-cyclic diols or comprising, relative to all of the monomers introduced, a molar amount of aliphatic non-cyclic diol units of less than 5%;
a step of introducing, into the reactor, a catalytic system;
a step of polymerizing said monomers to form the polyester, said step consisting of:
   a first stage of oligomerization, during which the reaction medium is stirred under an inert atmosphere at a temperature ranging from 265 to 280° C., advantageously from 270 to 280° C., for example 275° C.;
   a second stage of condensation of the oligomers, during which the oligomers formed are stirred under vacuum, at a temperature ranging from 278 to 300° C. so as to form the polyester, advantageously from 280 to 290° C., for example 285° C.;
a step of recovering the thermoplastic polyester.

This first stage of the process is carried out in an inert atmosphere, that is to say under an atmosphere of at least one inert gas. This inert gas may especially be dinitrogen. This first stage may be carried out under a gas stream and it may also be carried out under pressure, for example at a pressure of between 1.05 and 8 bar.

Preferably, the pressure ranges from 3 to 8 bar, most preferentially from 5 to 7.5 bar, for example 6.6 bar. Under these preferred pressure conditions, the reaction of all the monomers with one another is promoted by limiting the loss of monomers during this stage.

Prior to the first stage of oligomerization, a step of deoxygenation of the monomers is preferentially carried out. It can be carried out for example once the monomers have been introduced into the reactor, by creating a vacuum then by introducing an inert gas such as nitrogen thereto. This vacuum-inert gas introduction cycle can be repeated several times, for example from 3 to 5 times. Preferably, this vacuum-nitrogen cycle is carried out at a temperature of between 60 and 80° C. so that the reagents, and especially the diols, are totally molten. This deoxygenation step has the advantage of improving the coloration properties of the polyester obtained at the end of the process.

The second stage of condensation of the oligomers is carried out under vacuum. The pressure may decrease continuously during this second stage by using pressure decrease ramps, in steps, or else using a combination of pressure decrease ramps and steps. Preferably, at the end of this second stage, the pressure is less than 10 mbar, most preferentially less than 1 mbar.

The first stage of the polymerization step preferably has a duration ranging from 20 minutes to 5 hours. Advantageously, the second stage has a duration ranging from 30 minutes to 6 hours, the beginning of this stage consisting of the moment at which the reactor is placed under vacuum, that is to say at a pressure of less than 1 bar.

The process also comprises a step of introducing a catalytic system into the reactor. This step may take place beforehand or during the polymerization step described above.

Catalytic system is intended to mean a catalyst or a mixture of catalysts, optionally dispersed or fixed on an inert support.

The catalyst is used in amounts suitable for obtaining a high-viscosity polymer for the obtaining of the polymer composition.

An esterification catalyst is advantageously used during the oligomerization stage. This esterification catalyst can be chosen from derivatives of tin, titanium, zirconium, hafnium, zinc, manganese, calcium and strontium, organic catalysts such as para-toluenesulfonic acid (PTSA) or methanesulfonic acid (MSA), or a mixture of these catalysts. By way of example of such compounds, mention may be made of those given in application US 2011282020A1 in paragraphs [0026] to [0029], and on page 5 of application WO 2013/062408 A1.

Preferably, a zinc derivative or a manganese, tin or germanium derivative is used during the first stage of transesterification.

By way of example of amounts by weight, use may be made of from 10 to 500 ppm of metal contained in the catalytic system during the oligomerization stage, relative to the amount of monomers introduced.

At the end of transesterification, the catalyst from the first step can be optionally blocked by adding phosphorous acid or phosphoric acid, or else, as in the case of tin(IV), reduced with phosphites such as triphenyl phosphite or tris(nonylphenyl) phosphites or those cited in paragraph [0034] of application US 2011 282020A1.

The second stage of condensation of the oligomers may optionally be carried out with the addition of a catalyst. This catalyst is advantageously chosen from tin derivatives, preferentially derivatives of tin, titanium, zirconium, germanium, antimony, bismuth, hafnium, magnesium, cerium, zinc, cobalt, iron, manganese, calcium, strontium, sodium, potassium, aluminum or lithium, or of a mixture of these catalysts. Examples of such compounds may for example be those given in patent EP 1 882 712 B1 in paragraphs [0090] to [0094].

Preferably, the catalyst is a tin, titanium, germanium, aluminum or antimony derivative.

By way of example of amounts by weight, use may be made of from 10 to 500 ppm of metal contained in the catalytic system during the stage of condensation of the oligomers, relative to the amount of monomers introduced.

Most preferentially, a catalytic system is used during the first stage and the second stage of polymerization. Said system advantageously consists of a catalyst based on tin or of a mixture of catalysts based on tin, titanium, germanium and aluminum.

By way of example, use may be made of an amount by weight of 10 to 500 ppm of metal contained in the catalytic system, relative to the amount of monomers introduced.

According to the preparation process, an antioxidant is advantageously used during the step of polymerization of the monomers. These antioxidants make it possible to reduce the coloration of the polyester obtained. The antioxidants may be primary and/or secondary antioxidants. The primary antioxidant may be a sterically hindered phenol, such as the compounds Hostanox® 0 3, Hostanox® 0 10, Hostanox® 0 16, Ultranox® 210, Ultranox® 276, Dovernox® 10, Dovernox® 76, Dovernox® 3114, Irganox® 1010 or Irganox® 1076 or a phosphonate such as Irgamod® 195. The secondary antioxidant may be trivalent phosphorus compounds such as Ultranox® 626, Doverphos® S-9228, Hostanox® P-EPQ or Irgafos 168.

It is also possible to introduce as polymerization additive into the reactor at least one compound that is capable of limiting unwanted etherification reactions, such as sodium acetate, tetramethylammonium hydroxide or tetraethylammonium hydroxide.

Finally, the process comprises a step of recovering the polyester resulting from the polymerization step. The thermoplastic polyester thus recovered can subsequently be packaged in an easily handleable form, such as pellets or granules, before being again formed for the requirements of the 3D-printing.

According to one variant of the synthesis process, when the thermoplastic polyester is semicrystalline, a step of increasing the molar mass can be carried out after the step of recovering the thermoplastic polyester.

The step of increasing the molar mass is carried out by post-polymerization and may consist of a step of solid-state polycondensation (SSP) of the semicrystalline thermoplastic polyester or of a step of reactive extrusion of the semicrystalline thermoplastic polyester in the presence of at least one chain extender.

Thus, according to a first variant of the production process, the post-polymerization step is carried out by SSP.

SSP is generally carried out at a temperature between the glass transition temperature and the melting point of the polymer. Thus, in order to carry out the SSP, it is necessary for the polymer to be semicrystalline. Preferably the latter has a heat of fusion of greater than 10 J/g, preferably greater than 20 J/g, the measurement of this heat of fusion consisting in subjecting a sample of this polymer of lower reduced solution viscosity to a heat treatment at 170° C. for 16 hours, then in evaluating the heat of fusion by DSC by heating the sample at 10 K/min.

Advantageously, the SSP step is carried out at a temperature ranging from 190 to 280° C., preferably ranging from 200 to 250° C., this step imperatively having to be carried out at a temperature below the melting point of the semicrystalline thermoplastic polyester.

The SSP step may be carried out in an inert atmosphere, for example under nitrogen or under argon or under vacuum.

According to a second variant of the production process, the post-polymerization step is carried out by reactive extrusion of the semicrystalline thermoplastic polyester in the presence of at least one chain extender.

The chain extender is a compound comprising two functions capable of reacting, in reactive extrusion, with alcohol, carboxylic acid and/or carboxylic acid ester functions of the semicrystalline thermoplastic polyester. The chain extender may, for example, be chosen from compounds comprising two isocyanate, isocyanurate, lactam, lactone, carbonate, epoxy, oxazoline and imide functions, it being possible for said functions to be identical or different. The chain extension of the thermoplastic polyester may be carried out in any of the reactors capable of mixing a very viscous medium with stirring that is sufficiently dispersive to ensure a good interface between the molten material and the gaseous headspace of the reactor. A reactor that is particularly suitable for this treatment step is extrusion.

The reactive extrusion may be carried out in an extruder of any type, especially a single-screw extruder, a co-rotating twin-screw extruder or a counter-rotating twin-screw extruder. However, it is preferred to carry out this reactive extrusion using a co-rotating extruder.

The reactive extrusion step may be carried out by:
introducing the polymer into the extruder so as to melt said polymer;
then introducing the chain extender into the molten polymer;
then reacting the polymer with the chain extender in the extruder;
then recovering the semicrystalline thermoplastic polyester obtained in the extrusion step.

During the extrusion, the temperature inside the extruder is adjusted so as to be above the melting point of the polymer. The temperature inside the extruder may range from 150 to 320° C.

The semicrystalline thermoplastic polyester obtained after the step of increasing the molar mass is recovered and can subsequently be packaged in an easily handleable form, such as pellets or granules, before being again formed for the requirements of the 3D-printing.

The invention will be understood more clearly by means of the examples and figures below, which are intended to be purely illustrative and do not in any way limit the scope of the protection.

### EXAMPLES

The properties of the polymers were studied via the following techniques:

### Reduced Solution Viscosity

The reduced solution viscosity is evaluated using an Ubbelohde capillary viscometer at 25° C. in an equi-mass mixture of phenol and ortho-dichlorobenzene after dissolving the polymer at 130° C. with stirring, the concentration of the polymer introduced being 5 g/l.

### DSC

The thermal properties of the polyesters were measured by differential scanning calorimetry (DSC): The sample is first heated under a nitrogen atmosphere in an open crucible from 10° C. to 320° C. (10° C·min⁻¹), cooled to 10° C. (10° C·min⁻¹), then heated again to 320° C. under the same conditions as the first step. The glass transition temperatures were taken at the mid-point of the second heating. Any melting points are determined on the endothermic peak (onset) at the first heating.

Similarly, the enthalpy of fusion (area under the curve) is determined at the first heating.

For the illustrative examples presented below, the following reagents were used:

1,4-Cyclohexanedimethanol (99% purity, mixture of cis and trans isomers)

Isosorbide (purity >99.5%) Polysorb® P from Roquette Freres

Terephthalic acid (99+% purity) from Acros

Irganox® 1010 from BASF AG

Dibutyltin oxide (98% purity) from Sigma-Aldrich

### Example 1: Use of an Amorphous Thermoplastic Polyester for Producing a 3D-Printed Object

An amorphous thermoplastic polyester P1 is prepared for use according to the invention in 3D-printing.

### A: Polymerization

859 g (6 mol) of 1,4-cyclohexanedimethanol, 871 g (6 mol) of isosorbide, 1800 g (10.8 mol) of terephthalic acid, 1.5 g of Irganox 1010 (antioxidant) and 1.23 g of dibutyltin oxide (catalyst) are added to a 7.5 l reactor. To extract the residual oxygen from the isosorbide crystals, 4 vacuum-nitrogen cycles are carried out once the temperature of the reaction medium is between 60 and 80° C.

The reaction mixture is then heated to 275° C. (4° C./min) under 6.6 bar of pressure and with constant stirring (150 rpm). The degree of esterification is estimated from the amount of distillate collected. The pressure is then reduced to 0.7 mbar over the course of 90 minutes according to a logarithmic gradient and the temperature is brought to 285° C.

These vacuum and temperature conditions were maintained until an increase in torque of 10 Nm relative to the initial torque is obtained.

Finally, a polymer rod is cast via the bottom valve of the reactor, cooled to 15° C. in a heat-regulated water bath and chopped in the form of granules G1 of about 15 mg.

The resin thus obtained has a reduced solution viscosity of 54.9 ml/g.

The ¹H NMR analysis of the polyester P1 shows that it contains 44 mol % of isosorbide relative to the diols.

With regard to the thermal properties (measured at the second heating), the polyester P1 has a glass transition temperature of 125° C.

### B: Extrusion of the Granules in Order to Form a Rod

The granules G1 obtained in the preceding step are vacuum-dried at 110° C. in order to achieve residual moisture contents of less than 300 ppm. For this example, the water content of the granules is 210 ppm.

The extrusion of the rod/thread is carried out on a Collin extruder equipped with a die with two holes, each 1.75 mm in diameter, the assembly being completed by a cooled sizing die and a water cooling bath.

The extrusion parameters are collated in table 1 below:

TABLE 1

| Parameters | Units | Values |
|---|---|---|
| Temperature (feed -> die): | ° C. | 250/265/275/275/280 |
| Screw rotation speed | rpm | 80 |

At the extender outlet, the thread obtained has a diameter of 1.75 mm. It is then surface-dried after cooling by a stream of hot air at 60° C., then wound.

### C: Forming of a 3D-Printed Object by Fused Deposition Modeling

The spool is installed on a 3D-printing machine from the company Markerbot (Replicator 2).

The nozzle temperature is fixed at 185° C. and the bed is heated to 55° C.

The printed object obtained is a 3D polyhedron made up of several planar pentahedra linked to one another by the edges.

Visual observation makes it possible to note that the object produced exhibits no creep nor any cracks. Furthermore, the object obtained is transparent and also has a good surface finish.

Thus, the amorphous thermoplastic polyester according to the invention is particularly suitable for producing printed objects.

### Example 2: Use of a Semicrystalline Thermoplastic Polyester for Producing a 3D-Printed Object

A semicrystalline thermoplastic polyester P2 is prepared for use according to the invention in 3D-printing.

### A: Polymerization

1432 g (9.9 mol) of 1,4-cyclohexanedimethanol, 484 g (3.3 mol) of isosorbide, 2000 g (12.0 mol) of terephthalic acid, 1.65 g of Irganox 1010 (antioxidant) and 1.39 g of dibutyltin oxide (catalyst) are added to a 7.5 l reactor. To extract the residual oxygen from the isosorbide crystals, 4 vacuum-nitrogen cycles are carried out once the temperature of the reaction medium is at 60° C.

The reaction mixture is then heated to 275° C. (4° C./min) under 6.6 bar of pressure and with constant stirring (150 rpm) until a degree of esterification of 87% is obtained (estimated from the mass of distillate collected).

The pressure is then reduced to 0.7 mbar over the course of 90 minutes according to a logarithmic gradient and the temperature is brought to 285° C.

These vacuum and temperature conditions were maintained until an increase in torque of 12.1 Nm relative to the initial torque is obtained.

Finally, a polymer rod is cast via the bottom valve of the reactor, cooled to 15° C. in a heat-regulated water bath and chopped in the form of granules of about 15 mg.

Thus, the granules G2 are crystallized for 2 h in an oven under vacuum at 170° C.

A solid-state post-condensation step was carried out on 10 kg of these granules for 20 h at 210° C. under a stream of nitrogen (1500 l/h) in order to increase the molar mass. The resin after solid-state condensation has a reduced solution viscosity of 103.4 ml·g⁻¹.

The ¹H NMR analysis of the polyester shows that the polyester P2 contains 17.0 mol % of isosorbide relative to the diols.

With regard to the thermal properties, the polyester P2 has a glass transition temperature of 96° C. and a melting point of 253° C. with an enthalpy of fusion of 23.2 J/g.

### B: Extrusion of the Granules in Order to Form a Rod

The granules G2 are vacuum-dried at 150° C. in order to achieve residual moisture contents of less than 300 ppm. For this example, the water content of the granules is 110 ppm.

The extrusion of the rod/thread was carried out on a Collin extruder equipped with a die with two holes, each 1.75 mm in diameter, the assembly being completed by a cooled sizing die and a water cooling bath.

The extrusion parameters are collated in table 2 below:

TABLE 2

| Parameters | Units | Values |
|---|---|---|
| Temperature (feed -> die): | ° C. | 265/275/285/285/290 |
| Screw rotation speed | rpm | 80 |

At the extender outlet, the thread obtained has a diameter of 1.75 mm. It is then surface-dried after cooling by a stream of hot air at 60° C., then wound.

### C: Forming of a 3D-Printed Object by Fused Deposition Modeling

The spool is installed on a 3D-printing machine from the company Markerbot (Replicator 2).

The nozzle temperature is fixed at 270° C. and the bed is heated to 55° C.

The printed object obtained is a 3D polyhedron made up of several planar pentahedra linked to one another by the edges.

Visual observation makes it possible to note that the part produced exhibits no creep nor any cracks.

Recrystallization at 140° C. for 4 h makes it possible to render the object opaque and to increase its mechanical properties, in particular in terms of the impact strength.

The semicrystalline thermoplastic polyester according to the invention is thus also particularly suitable for producing 3D-printed objects.

1-20. (canceled)

21. A 3D-printed object comprising a thermoplastic polyester comprising:
at least one 1,4:3,6-dianhydrohexitol unit (A);
at least one alicyclic diol unit (B) other than the 1,4:3,6-dianhydrohexitol units (A); and
at least one terephthalic acid unit (C);
wherein the (A)/[(A)+(B)] ratio is at least 0.05 and at most 0.75;
said polyester not containing any aliphatic non-cyclic diol units or comprising a molar amount of aliphatic non-cyclic diol units, relative to all the monomer units of the polyester, of less than 5%, and the reduced solution viscosity (25° C.; phenol (50% m): ortho-dichlorobenzene (50% m); 5 of polyester) of said polyester being greater than 50 ml/g.

22. The 3D-printed object according to claim 21, wherein the alicyclic diol (B) is a diol chosen from 1,4-cyclohexanedimethanol, 1,2-cyclohexanedimethanol, 1,3-cyclohexanedimethanol or a mixture of these diols, very preferentially 1,4-cyclohexanedimethanol.

23. The 3D-printed object according to claim 21, wherein the 1,4:3,6-dianhydrohexitol (A) is isosorbide.

24. The 3D-printed object according to claim 21, wherein the polyester does not contain any aliphatic non-cyclic diol units, or comprises a molar amount of aliphatic non-cyclic diol units, relative to all the monomer units of the polyester, of less than 1%.

25. The 3D-printed object according to claim 21, wherein the (3,6-dianhydrohexitol unit (A)+alicyclic diol unit (B) other than the 1,4:3,6-dianhydrohexitol units (A))/(terephthalic acid unit (C)) molar ratio is from 1.05 to 1.5.

26. The 3D-printed object according to claim 21, wherein the 3D-printed object comprises one or more additional polymers and/or one or more additives.

27. A method for the production of a 3D-printed object, comprising the steps of:
a) provision of a thermoplastic polyester comprising at least one 1,4:3,6-dianhydrohexitol unit (A), at least one alicyclic diol unit (B) other than the 1,4:3,6-dianhydrohexitol units (A), at least one terephthalic acid unit (C), wherein the (A)/[(A)+(B)] ratio is at least 0.05 and at most 0.75, said polyester not containing any aliphatic non-cyclic diol units or comprising a molar amount of aliphatic non-cyclic diol units, relative to all the monomer units of the polyester, of less than 5%, and the reduced solution viscosity (25° C.; phenol (50% m): ortho-dichlorobenzene (50% m); 5 g/1 of polyester) of said polyester being greater than 50 ml/g.
b) forming of the thermoplastic polyester obtained in the preceding step,
c) 3D-printing of an object starting from the thermoplastic polyester formed, and
d) recovery of the 3D-printed object.

28. The method according to claim 27, wherein, in step b), the thermoplastic polyester is formed into a thread, a filament, a rod, granules, pellets or a powder.

29. The method according to claim 27, wherein the 3D-printing step c) is carried out by fused deposition modeling technique or by selective laser sintering technique.

30. The method according to claim 27, wherein the alicyclic diol (B) is a diol chosen from 1,4-cyclohexanedimethanol, 1,2-cyclohexanedimethanol, 1,3-cyclohexanedimethanol or a mixture of these diols, very preferentially 1,4-cyclohexanedimethanol.

31. The method according to claim 27, wherein the 1,4:3,6-dianhydrohexitol (A) is isosorbide.

32. The method according to claim 27, wherein the polyester does not contain any aliphatic non-cyclic diol units, or comprises a molar amount of aliphatic non-cyclic diol units, relative to all the monomer units of the polyester, of less than 1%.

33. The method according to claim 27, wherein the (3,6-dianhydrohexitol unit (A)+alicyclic diol unit (B) other than the 1,4:3,6-dianhydrohexitol units (A))/(terephthalic acid unit (C)) molar ratio is from 1.05 to 1.5.

34. The method according to claim 27, wherein the 3D-printed object comprises one or more additional polymers and/or one or more additives.
